(19) United States
(12) Patent Application Publication
(10) Pub. No.: US 2018/0028012 A1
(43) Pub. Date: Feb. 1, 2018

(54) SLOW COOKER APPLIANCE AND METHOD OF OPERATION

(71) Applicant: Haier US Appliance Solutions, Inc., Wilmington, DE (US)

(72) Inventor: Brent Alden Junge, Evansville, IN (US)

(21) Appl. No.: 15/224,731

(22) Filed: Aug. 1, 2016

(51) Int. Cl. A47J 27/00; A47J 36/38; A47J 36/32; F25B 13/00

(52) U.S. Cl. CPC A47J 27/004; F25B 13/00; A47J 36/38; A47J 36/32

(57) ABSTRACT

A slow cooker appliance and methods of operation are provided. The slow cooker appliance may include a casing, a heating element, a cooking utensil, and a sealed refrigeration system for circulating a refrigerant. The casing may define a utensil chamber. The heating element may be mounted within the casing proximate to the utensil chamber. The cooking utensil may be received within the utensil chamber. The sealed refrigeration system may include an evaporator and a compressor. The evaporator may be in conductive thermal engagement with the cooking utensil. The compressor may be positioned downstream from the evaporator to compress refrigerant from the evaporator.

### FIELD OF THE INVENTION

The present subject matter relates generally to cooking appliances, and more particularly to slow cooker appliances.

### BACKGROUND OF THE INVENTION

Slow cookers or slow cooking appliances generally include a heating element that is configured to slowing heat the contents (e.g., food items) within a ceramic pot. A lid may be positioned over the pot to trap heat and/or moisture, allowing food items within the ceramic pot to be slowly heated without becoming undesirably dry. Food items being heated within the pot often require little to no attention from a user. As a result, much of the preparation required may be performed well in advance of the time at which a user wishes to eat a given food item.

Although slow cooking appliances may reduce the amount of active time and effort that a user must expend, limitations still exist. For instance, although certain preparations may be done in advance of cooking or heating, most food items cannot be added until immediately before cooking operations begin. If added too soon, some food items, such as those that normally require refrigeration, may otherwise spoil. Moreover, once cooked, many food items will need to be quickly removed from the pot. From the pot, food items may be stored within a separate container and/or within a refrigerator. If left within the appliance or pot, some food items may overheat or spoil. Removal and/or storage of food items may be difficult, messy, and/or cumbersome. Although some pots are removable from the slow cooking appliance, a user's refrigerator may be unable to accommodate the pot. For instance, the pot may be too large, or the refrigerator may be otherwise full.

Accordingly, it would be advantageous to provide a slow cooker appliance that addressed the above concerns. In particular, it would be advantageous to provide a slow cooker appliance that included one or more features enabling food to be refrigerated or otherwise stored within the slow cooking appliance before and/or after cooking operations take place.

### BRIEF DESCRIPTION OF THE INVENTION

Aspects and advantages of the invention will be set forth in part in the following description, or may be obvious from the description, or may be learned through practice of the invention.

In one aspect of the present disclosure, a slow cooker appliance is provided. The slow cooker appliance may include a casing, a heating element, a cooking utensil, and a sealed refrigeration system for circulating a refrigerant. The casing may define a utensil chamber. The heating element may be mounted within the casing proximate to the utensil chamber. The cooking utensil may be received within the utensil chamber. The sealed refrigeration system may include an evaporator and a compressor. The evaporator may be in conductive thermal engagement with the cooking utensil. The compressor may be positioned downstream from the evaporator to compress refrigerant from the evaporator.

In another aspect of the present disclosure, a method of operating a slow cooker appliance is provided. The slow cooker appliance may include a casing defining a utensil chamber, a heating element, a cooking utensil received within the utensil chamber, an evaporator in conductive thermal engagement with the cooking utensil, and a compressor positioned downstream from the evaporator. The method may include determining a heating condition for the cooking utensil, and activating the heating element to transmit heat to the utensil chamber in response to the determined heating condition. The method may further include determining a cooling condition for the cooking utensil, and activating the compressor to circulate refrigerant within the sealed refrigeration system in response to the determined cooling condition.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a perspective view of a slow cooker appliance according to an exemplary embodiment of the present disclosure.

FIG. 2 provides a cross-sectional view of a slow cooker appliance according to an exemplary embodiment of the present disclosure.

FIG. 3 provides a top perspective view of an evaporator for a slow cooker appliance according to an exemplary embodiment of the present disclosure.

FIG. 4 provides a cross-sectional view of the exemplary evaporator of FIG. 3 along the line 4-4.

FIG. 5 provides a top perspective view of an evaporator for a slow cooker appliance according to an exemplary embodiment of the present disclosure.

FIG. 6 provides a cross-sectional view of the exemplary evaporator of FIG. 5 along the line 6-6.

FIG. 7 provides a flow chart of a method of slow cooker operation according to an exemplary embodiment of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

Generally, a slow cooker appliance is provided in exemplary embodiments of the present disclosure. The slow cooker appliance may include a casing that houses an electric heating element. The casing may be shaped to receive a cooking utensil, such as a ceramic or aluminum pot. The cooking utensil is generally configured to hold or contain food items to be cooked. An evaporator may be placed beneath the cooking utensil as part of a sealed cooling system. During use, the electric heating element and sealed cooling system may be alternately or alternatively activated to respectively heat and cool food items within the cooking utensil.

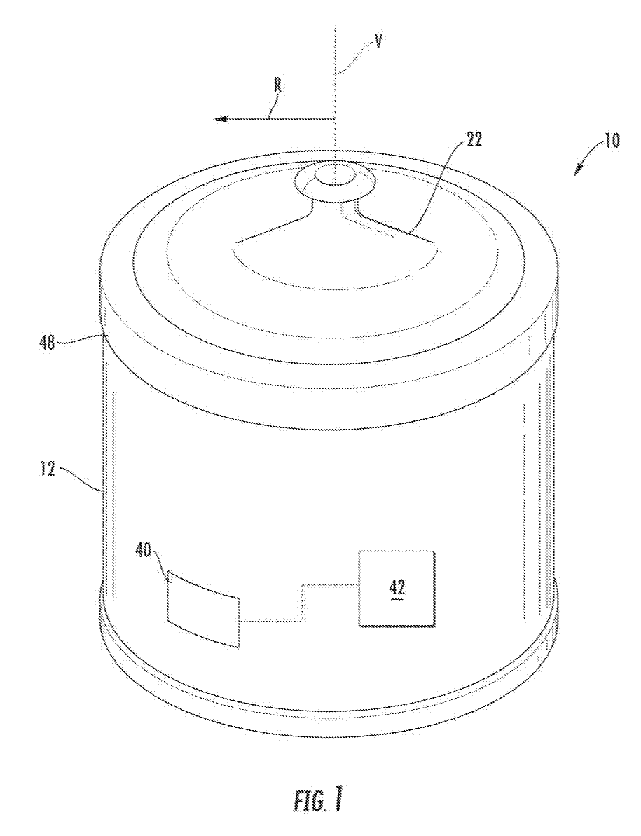

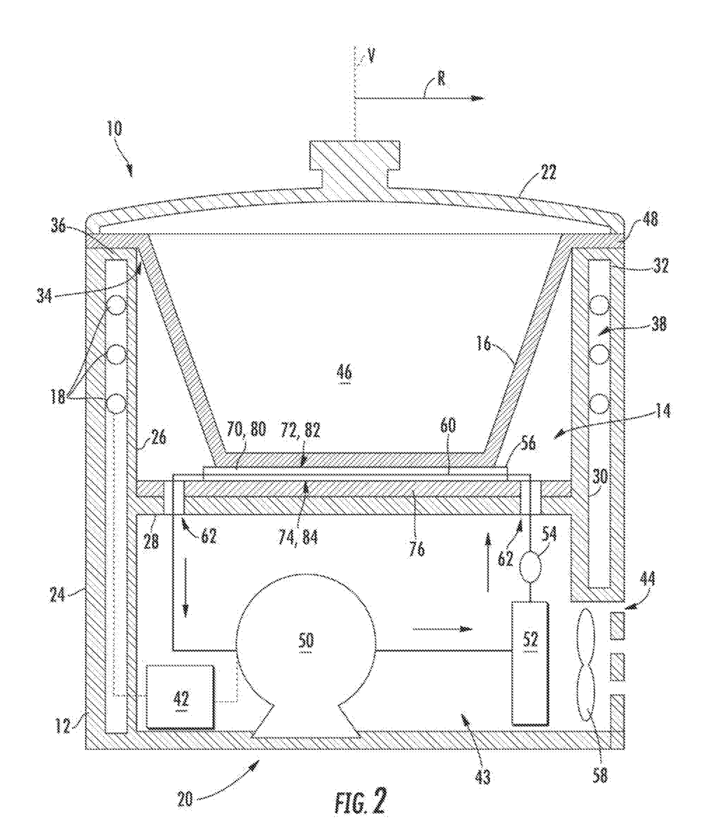

Turning now to the figures, FIGS. 1 and 2 provide an exemplary embodiment of a slow cooker appliance 10. As illustrated, slow cooker appliance 10 generally includes a casing 12 that defines a utensil chamber 14. A cooking utensil 16, such as a pot, may be positioned or received at least partially within casing 12, e.g., at utensil chamber 14. A heating element 18 and sealed cooling system 20 may be provided to selectively heat or cool cooking utensil 16. A lid 22 may also be provided. During use, lid 22 may be selectively placed on or over cooking utensil 16 to restrict air and/or heat passage therethrough. As will be understood, certain items, such as food, can be placed into cooking utensil 16. When cooking utensil 16 is disposed within casing 12, appliance 10 may heat and/or cool the provided food items, as will be described below.

As shown, casing 12 includes one or more unique walls 24, 26, 28. The walls 24, 26, 28 may define utensil chamber 14. For instance, an inner wall 26 may define at least a portion of utensil chamber 14, e.g., in a vertical direction V defined by casing 12. An outer wall 24 is disposed radially outward from utensil chamber 14 and inner wall 26 (i.e., outward in a radial direction R defined by casing 12). Inner wall 26 may be positioned radially between outer wall 24 and utensil chamber 14. One or more of outer wall 24 or inner wall 26 may extend, e.g., substantially in the vertical direction V. In some embodiments, inner wall 26 at least partially defines utensil chamber 14 between a lower edge 30 and an upper edge 32. An internal base wall 28 may extend across a bottom portion of utensil chamber 14, defining utensil chamber 14, e.g., as a lowermost vertical extreme. Bottom wall 28 may extend in the radial direction R and/or connect lower edge 30 of the inner wall 26. Upper edge 32 of inner wall 26 may be positioned opposite of the lower edge 30 to define an opening 34. As shown, opening 34 generally permits access to utensil chamber 14. In certain embodiments, a top rim 36 extends radially outward from the upper edge 32. Optionally, top rim 36 may join inner wall 26 to outer wall 24. Additionally or alternatively, top rim 36 may support cooking utensil 16, e.g., when cooking utensil 16 is received within utensil chamber 14.

Between outer wall 24 and inner wall 26, casing 12 may define an element chamber 38. In some such embodiments, a heating element 18 may be mounted therein. For instance, heating element 18 may be mounted proximate to utensil chamber 14 to provide heat thereto. In certain embodiments, heating element 18 is mounted in fixed contact with inner wall 26. Optionally, insulation (e.g., foam insulation) may be mounted within element chamber 38. Additionally or alternatively, air may insulate the space between heating element 18 and outer wall 24. Upon being mounted, heating element 18 may be radially spaced between inner wall 26 and outer wall 24. Additionally or alternatively, heating element 18 may be disposed about utensil chamber 14, e.g., such that heating element 18 substantially surrounds utensil chamber 14. In some embodiments, heating element 18 is shaped as a single ring (either partially or fully surrounding utensil chamber 14). In alternative embodiments, heating element 18 is shaped as a helical coil. However, other suitable shapes may also be provided in additional or alternative embodiments.

In the illustrated embodiments, heating element 18 is an electric resistive heating element 18. Although a single coiled resistive heating element 18 is shown, multiple discrete heating elements 18 may be provided in alternative embodiments. As discussed in greater detail below, each heating element 18 may be operably connected (e.g., electrically coupled) to a user interface 40 and/or controller 42 configured to control one or more elements of appliance 10.

In some embodiments, casing 12 defines an enclosed chamber 43 that houses all or some of sealed cooling system 20. For instance, enclosed chamber 43 may be defined below internal base wall 28. One or more vent apertures 44 may be defined through casing 12, e.g., in fluid communication with enclosed chamber 43, to permit air exchange between the ambient environment and enclosed chamber 43.

As noted above, cooking utensil 16 may be received within utensil chamber 14. Cooking utensil 16 generally defines a food cavity 46 to hold food within appliance 10, e.g., during heating or cooling operations. Cooking utensil 16 may be formed from one or more suitable heat-resistant materials, such as aluminum, glass, ceramic, laminates, plastics, another metal, etc. In some embodiments, cooking utensil 16 is permanently mounted to casing 12. In alternative embodiments, cooking utensil 16 removably rests on a portion of casing 12. For instance, a radial band 48 of cooking utensil 16 may rest upon top rim 36. In turn, cooking utensil 16 may be selectively removed, e.g., by lifting radial band 48 off of top rim 36 and drawing the remaining portion of cooking utensil 16 away from utensil chamber 14.

A sealed cooling system 20 is provided to circulate a refrigerant fluid therein. As illustrated, exemplary embodiments of sealed cooling system 20 include a compressor 50, a condenser 52, a throttling device 54, and an evaporator 56. Evaporator 56 is generally provided in conductive thermal engagement with cooking utensil 16 (e.g., at a bottom portion of cooking utensil 16). Compressor 50 is generally positioned downstream evaporator 56 to compress refrigerant from evaporator 56.

As is generally understood, various conduits may be utilized to flow or direct refrigerant between the various components of the sealed system 20. The compressor 50, condenser 52, throttling device 54, and evaporator 56 may each be placed in fluid communication such that refrigerant generally flows downstream from the compressor 50 to the rest of the system before returning to the compressor 50.

During operation, the compressor 50 motivates the refrigerant through the sealed cooling system 20 and acts to compress the refrigerant through the compressor 50, increasing pressure and temperature of the refrigerant such that the refrigerant becomes a superheated vapor. As a superheated vapor, the refrigerant then passes to the condenser 52, which may be positioned directly downstream from the compressor 50. Within the condenser 52, the refrigerant is cooled as heat is drawn therefrom. The refrigerant subsequently exits the condenser 52 as a saturated liquid and/or high quality liquid vapor mixture. Optionally, a fan 58 may be provided adjacent to the compressor 50, in fluid isolation from the refrigerant. During operation, fan 58 may force and/or direct air (e.g., through vent apertures 44) across condenser 52 and accelerate heat transfer between condenser 52 and the ambient environment.

From the condenser 52, the saturated liquid and/or high quality liquid vapor mixture travels through the throttling device 54, which is configured for regulating a flow rate of refrigerant therethrough. The throttling device 54 may generally expand the refrigerant, lowering the refrigerant's pressure and temperature. As a result, a cooled form of the refrigerant passes to the evaporator 56. While passing through the evaporator 56, the cooled refrigerant absorbs heat transferred to evaporator 56 from cooking utensil 16 and/or any items therein. Refrigerant may exit the evaporator 56 in a gasified vapor form before passing back to the compressor 50. Additional elements, such as an accumulator (not pictured) may be provided in some embodiments and may be configured to maintain gasification of the fluid flow as the refrigerant passes from the evaporator 56 to the compressor 50. Upon the refrigerant reaching the compressor 50, the cycle repeats.

A user interface 40 and/or controller 42 are included in exemplary appliance embodiments. User interface 40 generally includes one or more interface elements, such as a button, switch, touch screen, or display to receive user inputs and/or provide information regarding the slow cooker appliance 10. In optional embodiments, user interface 40 is mounted to casing 12, e.g., at outer wall 24. Controller 42 may be operably connected to user interface 40 and configured to control or regulate the heating element 18 and/or sealed cooling system 20.

Controller 42 may include memory and one or more processing devices such as microprocessors, CPUs or the like, such as general or special purpose microprocessors operable to execute programming instructions or micro-control code associated with operation of the slow cooker appliance 10. The memory can represent random access memory such as DRAM, or read only memory such as ROM or FLASH. The processor executes programming instructions stored in the memory. The memory can be a separate component from the processor or can be included onboard within the processor. Alternatively, controller 42 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

In some embodiments, controller 42 is operably connected (e.g., electrically coupled) to heating element 18 and a portion of sealed cooling system 20, such as the compressor 50. Controller 42 is configured to selectively and/or separately activate heating element 18 and compressor 50 according to one or more input signals.

In certain embodiments, controller 42 is configured to determine a heating condition for cooking utensil 16. Heating condition may generally correspond to a demand for heat to be generated at heating element 18. In turn, controller 42 may activate heating element 18 in response to the determined heating condition. In optional embodiments, determination of a heating condition includes receiving a user-selected heating signal from user interface 40. In additional or alternative embodiments, determination of a heating condition includes determining that a set timing condition has been met, e.g., according to a provided cook cycle. The timing condition for heating element 18 may be predetermined or prescribed according to a selected user input. For instance, the timing condition for heating element 18 may be a selected clock time or an elapsed time period. Heating element 18 may activate at the selected clock time or at the end of the elapsed time period. In still further additional or alternative embodiments, determination of a heating condition includes detecting a temperature threshold (e.g., temperature set point or range).

Upon being activated, heating element 18 may continue to operate. Operation may be subsequently ceased as dictated by controller 42. For instance, controller 42 may determine a stop time has elapsed. The stop time of the heating element 18 may be a selected clock time or an elapsed time period. Heating element 18 may deactivate or cease to operate at the selected clock time or at the end of the elapsed time period. Additionally or alternatively, operation of heating element 18 may be ceased in response to controller 42 detecting a temperature threshold (e.g., temperature set point or range). Optionally, operation of heating element 18 may be ceased in response to determination of a cooling condition.

In some embodiments, controller 42 is configured to determine a cooling condition for cooking utensil 16. Cooling condition may generally correspond to a demand to draw heat away from cooking utensil 16, e.g., via evaporator 56. Controller 42 may activate compressor 50 in response to the determined cooling condition. In optional embodiments, determination of a cooling condition includes receiving a user-selected refrigeration signal from user interface 40. In additional or alternative embodiments, determination of a cooling condition includes determining that a set timing condition has been met, e.g., according to a provided cook cycle. The timing condition for compressor 50 may be predetermined or prescribed according to a selected user input. For instance, the timing condition for compressor 50 may be a selected clock time or an elapsed time period. Compressor 50 may activate at the selected clock time or at the end of the elapsed time period. In still further additional or alternative embodiments, determination of a cooling condition includes detecting a temperature threshold (e.g., temperature set point or range). For instance, compressor 50 may be activated periodically based on a set temperature threshold.

Upon being activated, compressor 50 may continue to operate. Operation may be subsequently ceased as dictated by controller 42. For instance, controller 42 may determine a stop time has elapsed. The stop time of the compressor 50 may be a selected clock time or an elapsed time period. Compressor 50 may deactivate or cease to circulate refrigerant at the selected clock time or at the end of the elapsed time period. Additionally or alternatively, operation of compressor 50 may be ceased in response to controller 42 detecting a temperature threshold (e.g., temperature set point or range). Optionally, operation of compressor 50 may be ceased in response to determination of a heating condition.

Activation of compressor 50 may optionally occur before activation of heating element 18. Additionally or alternatively, activation of compressor 50 may occur after activation of heating element 18. In some embodiments, multiple unique cooking cycles are provided (e.g., within controller 42) to activate heating element 18 and compressor 50 separately according to discrete patterns or cycles of operation. For instance, certain cooking cycles include activating compressor 50 to chill food items within the cooking utensil 16. After a selected cooling time, compressor 50 is deactivated and heating element 18 is activated to heat the food items. Advantageously, food items may be placed within cooking utensil 16 far in advance of when the food needs to be cooked, while still being held in a reduced preservation temperature. In additional or alternative cooking cycles, activating heating element 18 is included to heat and cook food items within cooking utensil 16. After food is adequately cooked (e.g., after a selected cooking time), heating element 18 is deactivated and compressor 50 is activated to chill the food items. Advantageously, cooked food items may be stored for extended periods of time within cooking utensil 16, while still being held in a reduced preservation temperature.

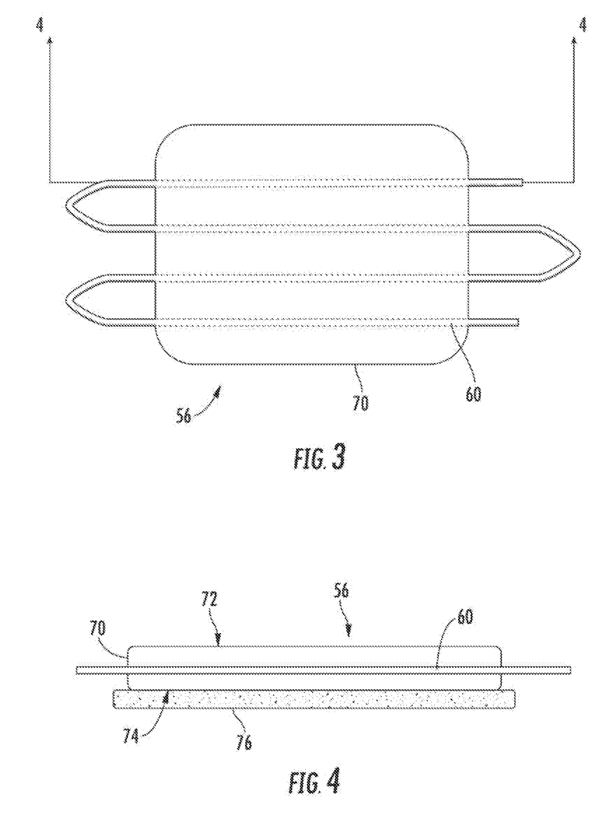

Turning now to FIGS. 3 and 4, an exemplary evaporator 56 embodiment is illustrated. As shown, evaporator 56 includes a conduit segment 60 to direct refrigerant therethrough. In some embodiments, a rigid conductive plate 70 is provided. When assembled, rigid conductive plate 70 may be in thermal contact with at least a portion of conduit segment 60. Optionally conduit segment 60 may be fixed to conductive plate 70. For example, conduit segment 60 may extend through rigid conductive plate 70 between a top surface 72 of rigid conductive plate 70 and a bottom surface 74 of rigid conductive plate 70. At least a portion of conduit segment 60 may be defined within rigid conductive plate 70. Additionally or alternatively, conduit segment 60 may include an arcuate and/or serpentine shape. Several passes of conduit segment 60 may be disposed within rigid conductive plate 70 and provide a distributed contact surface with rigid conductive plate 70.

As illustrated in FIG. 2, evaporator 56, which optionally includes rigid conductive plate 70, may be positioned away from heating element 18. When cooking utensil 16 is disposed within utensil chamber 14, evaporator 56 may be positioned between internal base wall 28 and cooking utensil 16. Top surface 72 may face cooking utensil 16 (e.g., such that bottom surface 74 is in contact with the bottom portion of cooking utensil 16). Bottom surface 74 may face away from cooking utensil 16, e.g., toward internal base wall 28. One or more conduit apertures 62 may be defined through base wall 28 to permit the passage of conduit to/from additional components of sealed cooling system 20, e.g., compressor 50 within enclosed cavity. Advantageously, separation between heating element 18 and evaporator 56 may prevent damage to rigid conductive plate 70 and allow for lower heat tolerances in the sealed cooling system 20.

Returning to FIGS. 3 and 4, conduit segment 60 and rigid conductive plate 70 may be formed from one or more suitable conductive materials. The materials of conduit segment 60 and rigid conductive plate 70 may be the same, or they may be discrete materials. For instance, conduit segment 60 may be formed from a first conductive material (e.g., copper, steel, or an alloy thereof) while rigid conductive plate 70 is formed from another conductive material (e.g., aluminum or an alloy thereof). In certain embodiments, rigid conductive plate 70 is formed from a suitable conductive material being poured in molten form over conduit segment 60. Additionally or alternatively, rigid conductive plate 70 may be die cast with conduit segment 60.

In some embodiments, a compressive substrate 76 at least partially supports evaporator 56 (see also FIG. 2). For instance, compressive substrate 76 may be disposed on internal base wall 28, below rigid conductive plate 70. Compressive substrate 76 may be positioned between internal base wall 28 and rigid conductive plate 70. In some such embodiments, bottom surface 74 of rigid conductive plate 70 is disposed on top of compressive substrate 76 (e.g., in contact within compressive substrate 76), while internal base wall 28 supports compressive substrate 76 below. When cooking utensil 16 is disposed within utensil chamber 14, compressive substrate 76 may bias rigid conductive plate 70 toward the bottom portion of cooking utensil 16, advantageously ensuring thermal contact between evaporator 56 and cooking utensil 16. Compressive substrate 76 may include one or more suitable elastic structures, such as a foam rubber panel or compression spring, to resiliently deform and/or bias evaporator 56 toward cooking utensil 16.

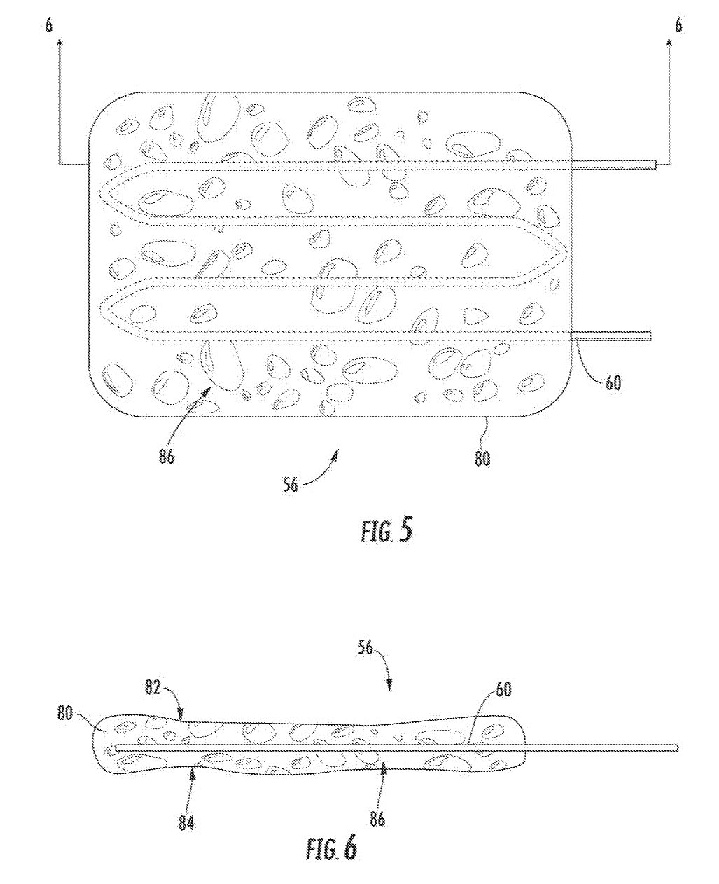

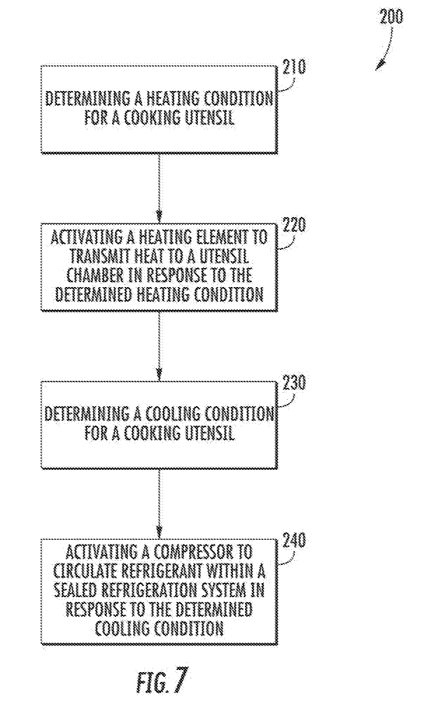

Turning now to FIGS. 5 and 6, another exemplary evaporator 56 is illustrated. As shown, evaporator 56 includes a conduit segment 60 to direct refrigerant therethrough. In some embodiments, a resilient bladder 80 is provided. At least a portion of the conduit segment 60 may extend within the resilient bladder 80. For example, conduit segment 60 may extend within resilient bladder 80 between a top bladder surface 82 and a bottom bladder surface 84.

In some embodiments, a flowable conductive material 86 may is disposed within resilient bladder 80. The conductive material 86 may include one or more suitable liquid, fluid, or particulate (e.g., water, propylene glycol, or particulate aluminum). When assembled, the flowable conductive material 86 may surround at least a portion of the conduit segment 60 in fluid isolation from the refrigerant. For instance, in some embodiments the flowable conductive material 86 contacts conduit segment 60 in conductive thermal engagement. Refrigerant may flow through conduit segment 60 without contacting or intermingling with flowable conductive material 86. Conduit segment 60 may include an arcuate and/or serpentine shape. Several passes of conduit segment 60 may be disposed within resilient bladder 80 and provide a distributed contact surface with flowable conductive material 86.

In some embodiments, evaporator 56, including resilient bladder 80, may be positioned away from heating element 18 (see FIG. 2). When cooking utensil 16 is disposed within utensil chamber 14, evaporator 56 may be positioned between internal base wall 28 and cooking utensil 16. Top bladder surface 82 may face cooking utensil 16 (e.g., such that bottom surface 74 is in contact with the bottom portion of cooking utensil 16). Bottom bladder surface 84 may face away from cooking utensil 16, e.g., toward internal base wall 28. One or more conduit apertures 62 (see FIG. 2) may be defined through base wall 28 to permit the passage of conduit to/from additional components of sealed cooling system 20, e.g., compressor 50 within enclosed cavity. Advantageously, separation between heating element 18 and evaporator 56 may prevent damage to resilient bladder 80 and allow for lower heat tolerances in the sealed cooling system 20.

Resilient bladder 80 may be formed from one or more suitable flexible materials, such as silicone rubber. Conduit segment 60 may be formed from one or more suitable conductive materials (e.g., aluminum, copper, steel, or an alloy thereof).

Turning now to FIG. 7, a method 200 for operating a slow cooker appliance according to an exemplary embodiment of the present disclosure is illustrated. Method 200 may be used to operate any suitable slow cooker appliance. As an example, method 200 may be used to operate slow cooker appliance 10 (see FIG. 1). Controller 42 (see FIG. 1) may be programmed to implement method 200.

At 210, method 200 includes determining a heating condition for a cooking utensil. As discussed above, the heating condition may correspond to a demand for heat to be generated and/or provided to cooking utensil. The heating condition may indicate a specific temperature, relative temperature, or a general demand for heat. Determination 210 may be made, for instance, in response to a user input signal. The user input may be made according to an immediate or a delayed desired for heat (e.g., according to a predetermined program). In additional or alternative embodiments, 210 includes determining that a set timing condition has been met, e.g., according to a provided cook cycle.

At 220, method 200 includes activating the heating element to transmit heat to the utensil chamber in response to the determined heating condition at 210. The heating element may be activated continuously, or according to a predetermined pattern (e.g., a periodic pattern). After the heating element has been activated, the method 200 may provide for deactivating the heating element, as described above.

At 230, method 200 includes determining a cooling condition for the cooking utensil. The cooling condition may indicate a specific temperature, relative temperature, or a general demand for heat. Determination 230 may be made, for instance, in response to a user input signal. The user input may be made according to an immediate or a delayed desired for a reduction in heat (e.g., according to a predetermined program). In additional or alternative embodiments, 230 condition includes determining that a set timing condition has been met, e.g., according to a provided cook cycle.

At 240, method 200 includes activating the compressor to circulate refrigerant within the sealed refrigeration system in response to the determined cooling condition at 230. The compressor may be activated continuously, are according to a predetermined pattern (e.g., a periodic pattern). After the compressor has been activated, the method 200 may provide for deactivating the compressor, as described above.

It is understood that 240 may occur before or after 220, depending on the desired heating or cooling demands, e.g., according to a provided cook cycle. Moreover, one or more of the method steps 210, 220, 230, 240 may be repeated or reordered without departing from the envisioned method 200. For example, multiple instances of step 240 may be optionally provided, including one instance of step 240 before step 220, and another instance of step 240 after step 240 (e.g., according to a predetermined program).

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A slow cooker appliance comprising:
a casing defining a utensil chamber;
a heating element mounted within the casing proximate the utensil chamber;
a cooking utensil received within the utensil chamber; and
a sealed refrigeration system for circulating a refrigerant, the sealed refrigeration system comprising
an evaporator in conductive thermal engagement with the cooking utensil, and
a compressor positioned downstream from the evaporator to compress refrigerant from the evaporator.

2. The slow cooker appliance of claim 1, wherein the casing defines an enclosed chamber beneath the utensil chamber, and wherein the compressor is mounted within the enclosed chamber.

3. The slow cooker appliance of claim 2, wherein the sealed refrigeration system includes a condenser positioned in fluid communication between the compressor and the evaporator to condense refrigerant received from the condenser.

4. The slow cooker appliance of claim 3, further comprising a fan positioned within the enclosed chamber to direct an airflow across the condenser.

5. The slow cooker appliance of claim 1, wherein the casing includes an outer sidewall and an inner sidewall, and wherein the heating element is mounted about the utensil chamber between the outer sidewall and the inner sidewall.

6. The slow cooker appliance of claim 1, wherein the casing includes an internal base wall disposed below the cooking utensil.

7. The slow cooker appliance of claim 6, wherein the evaporator is positioned between the internal base wall and the cooking utensil.

8. The slow cooker appliance of claim 7, further comprising a compressive substrate disposed on the internal base wall between the evaporator and the internal base wall.

9. The slow cooker appliance of claim 7, wherein the evaporator includes a rigid conductive plate in contact with the cooking utensil.

10. The slow cooker appliance of claim 7, wherein the evaporator includes a resilient bladder in contact with the cooking utensil.

11. The slow cooker appliance of claim 10, wherein the evaporator further includes a flowable conductive material disposed within the resilient bladder and in fluid isolation from the refrigerant.

12. The slow cooker appliance of claim 1, further comprising a controller configured to:
determine a heating condition for the cooking utensil,
activate the heating element in response to the determined heating condition,
determine a cooling condition for the cooking utensil, and
activate the compressor in response to the determined cooling condition.

13. A method of operating a slow cooker appliance, the slow cooker appliance comprising a casing defining a utensil chamber, a heating element, a cooking utensil received within the utensil chamber, an evaporator in conductive thermal engagement with the cooking utensil, and a compressor positioned downstream from the evaporator, the method comprising:
determining a heating condition for the cooking utensil;
activating the heating element to transmit heat to the utensil chamber in response to the determined heating condition;
determining a cooling condition for the cooking utensil; and
activating the compressor to circulate refrigerant within the sealed refrigeration system in response to the determined cooling condition.

14. The method of claim 13, wherein determining a cooling condition includes determining a timing condition has been met.

15. The method of claim 12, wherein determining a cooling condition includes receiving a user-selected refrigeration signal.

16. The method of claim 13, wherein activating the compressor occurs after activating the heating element.

17. The method of claim 16, further comprising deactivating the heating element in response to determining a cooling condition.

18. The method of claim 13, wherein activating the heating element occurs after activating the compressor.

19. The method of claim 18, further comprising deactivating the compressor in response to determining a heating condition.

20. The method of claim 13, wherein activating the compressor includes periodically activating the compressor based on a temperature threshold.
